(19) United States
(12) Patent Application Publication
(10) Pub. No.: US 2015/0234515 A1
(43) Pub. Date: Aug. 20, 2015

(54) Determination of an Input Position on a Touchscreen

(71) Applicant: Bayerische Motoren Werke Aktiengesellschaft, Muenchen (DE)

(72) Inventor: Bernhard GASSER, Muenchen (DE)

(21) Appl. No.: 14/699,176

(22) Filed: Apr. 29, 2015

Related U.S. Application Data
(63) Continuation of application No. PCT/EP2013/071950, filed on Oct. 21, 2013.

(30) Foreign Application Priority Data
Oct. 31, 2012 (DE) 10 2012 219 958.6

(51) Int. Cl. G06F 3/041; G06F 3/042

(52) U.S. Cl. CPC G06F 3/0412; G06F 3/0425; G06F 2203/04106

(57) ABSTRACT

A method is provided for determining an input position on a touch-sensitive display by a user. The method includes the following steps: detecting the position of the eyes of the user, in particular with the aid of a camera; detecting the position of a contact with the touch-sensitive display; and determining the input position based on the detected position of the eyes relative to at least a portion of the touch-sensitive display, in particular in relation to a graphical element shown on the display, and the detected position of the contact.

### CROSS REFERENCE TO RELATED APPLICATIONS

This application is a continuation of PCT International Application No. PCT/EP2013/071950, filed Oct. 21, 2013, which claims priority under 35 U.S.C. §119 from German Patent Application No. 10 2012 219 958.6, filed Oct. 31, 2012, the entire disclosures of which are herein expressly incorporated by reference.

### BACKGROUND AND SUMMARY OF THE INVENTION

The invention relates to a method for determining an input position on a touch-sensitive display and to a device for the same purpose.

Touch-sensitive displays, sometimes also referred to as touch screens, are widely common today, especially in what are known as smart phones. The use of touch screens in motor vehicles has been considered. A fundamental factor for the interaction with touch screens and the content displayed thereon, such as buttons, is that the input request of a user, which is to say the position that the user would like to touch on the surface of the touch screen, hereinafter referred to as the input position, is correctly determined.

Published prior art U.S. 2010/0079405 A1, for this purpose, proposes methods that attempt to use the analysis of properties of the touch area to infer the input request of the user. The methods are based exclusively on the inherent properties of the contact itself, and other sources for analyzing the contact are disregarded.

There is therefore needed an improved device and an improved method, which can be used to determine the input position.

This and other needs are met according to the invention by providing a method for determining an input position on a touch-sensitive display by a user, which method includes the following steps: detecting the position of the eyes of the user, in particular with the aid of a camera; detecting the position of a contact with the touch-sensitive display; and determining the input position based on the detected position of the eyes relative to at least a portion of the touch-sensitive display, in particular relative to a graphical element shown on the display, and the detected position of the contact.

In this way, the position from which the user looks at the touch-sensitive display is taken into consideration. Deviations in the input that results from comparing the input to input of an ideal position can therefore be taken into consideration.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1A is a schematic example in a top view of a user operating a touch-sensitive display;

FIG. 1B is a side view with respect to FIG. 1A;

FIG. 1C is a schematic example illustrating, in a top view, different users operating a touch-sensitive display;

FIGS. 2A and 2B are top and side views, respectively, illustrating a schematic example of a user operating the touch-sensitive display while viewing the display obliquely;

FIGS. 3A and 3B are schematic illustrations in a top and side view, respectively, of a system according to an exemplary embodiment of the invention.

### DETAILED DESCRIPTION OF THE DRAWINGS

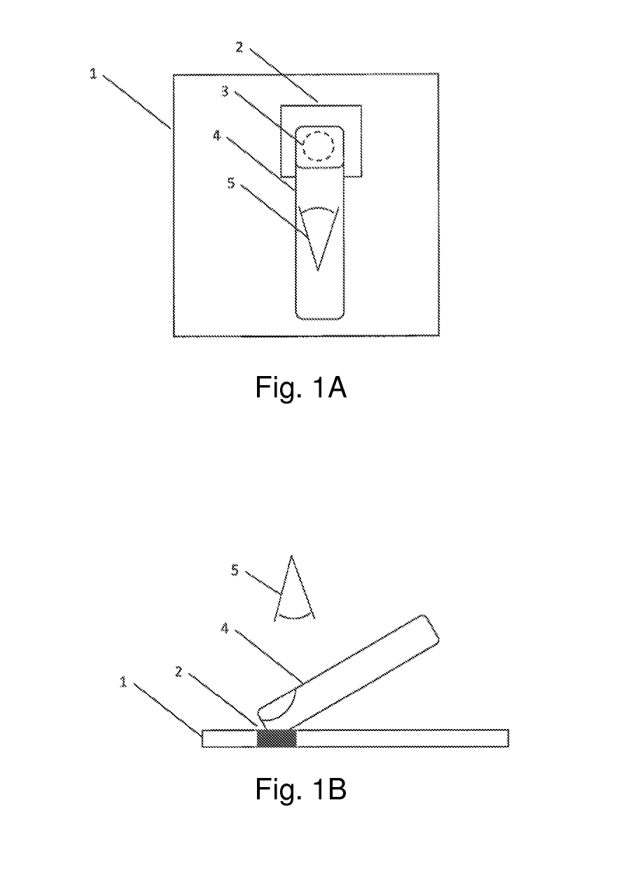

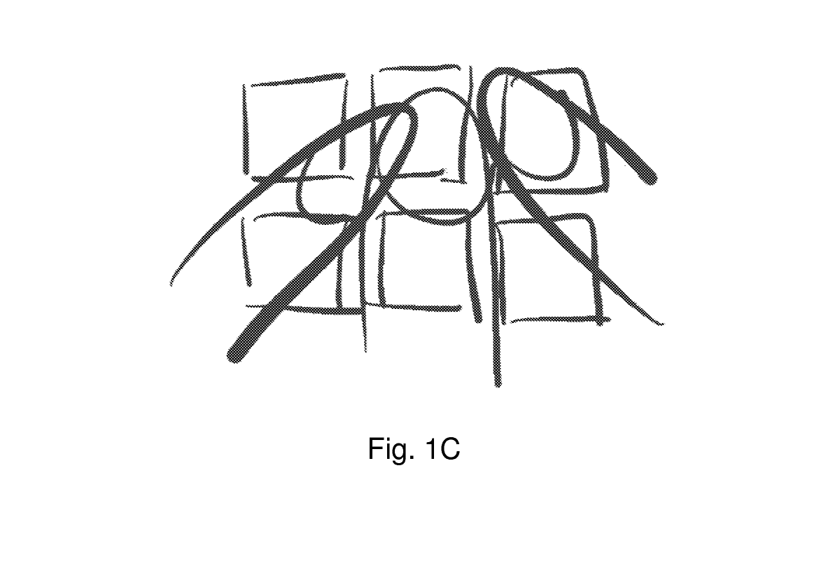

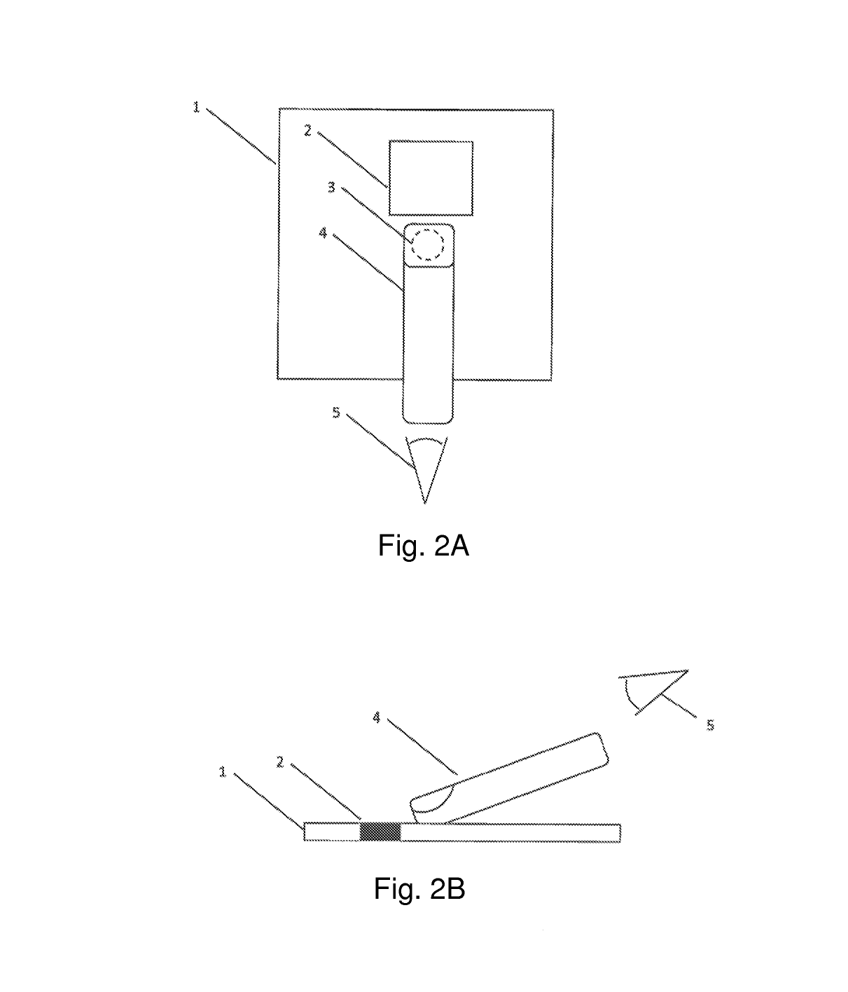

A schematic example is shown in a top view in FIGS. 1A and 2A, and FIGS. 1B and 2B each show a side view of the same situation. FIGS. 1A and 1B show the input of a user (not shown) whose eyes 5 (shown only symbolically) are located almost vertically above a touch-sensitive display 1. The user wants to touch what is known as the button 2, therefore generating the touch area 3 with his finger 4 (the fingernail being indicated) on the surface of the display 1, wherein the touch area 3 is associated with a position of the contact, for example the centroid of the touch area. FIGS. 2A and 2B show the input of a user who is looking obliquely onto the touch-sensitive display 1, which is to say at an angle. Identical reference numerals denote corresponding elements. As is apparent, the touch area 3 of the user looking obliquely onto the display is offset with respect to the button 2. This offset is created because the finger 4 of the user appears to cover the button 2 from the view of the obliquely looking user, although this is in fact not the case. The associated touch position is also located outside the button 2. The user assumes that the finger 4 is located above the button 2, and that the corresponding touch area 3 and the associated touch position are located on the button 2 in corresponding fashion.

It is possible to correct the offset in the position of the contact resulting from the oblique view of the user onto the display by detecting and considering the position of the eyes of the user and the known position of the touch-sensitive display, parts thereof, such as the touch position, or of a graphical element, such as a button. The determination of the input position is therefore improved, and the input request of the user is better identified.

The position of the eyes can be determined based on image processing methods that are generally known. The eyes can be identified individually, based on which a representative viewing position is then determined. The term “position of the eyes” herein also includes the representative viewing position.

The portion of the display can be the entire display itself or—especially in the case of curved display surfaces—the portion relevant for the input, and a graphical element, such as the button, of a displayed graphical interface. The graphical element can be selected based on a smallest distance from the position of the contact compared to other graphical elements.

In the determination of the input position, a user position can be inferred from the detection of the eyes. This means, for example, whether the user is located to the right or to the left of the display. In the event that the display is installed in the center console of a vehicle, it is possible to determine in this way whether the driver or the front-seat passenger is operating the display. The determination of the input position then takes into consideration whether a driver or front-seat passenger is involved and determines the input position as a function of this preparatory determination, for example by shifting the touch position or area. A deviation in the touch position or area in the direction of the user position can be assumed for this purpose. FIG. 1C shows typical finger positions for a contact with the display for a driver (finger left), a user located centrally behind the display (finger in the middle) and a front-seat passenger (finger right). As is apparent, the positions of the contact for the driver and the front-seat passenger are offset in the respective direction. The deviation in the position of the touch area or in the touch position can be dependent on the angle, which is to say dependent on how far the user is offset to the left or right from the center position directly behind the display.

In one advantageous refinement, the input position is determined proceeding from the position of the contact, which is adapted based on an angle that is associated with the position of the eyes relative to the at least one portion of the display, in particular in such a way that the smaller the angle the greater the adaptation, wherein the angle is measured proceeding from the display. Proceeding from the display surface, the angle is determined on at least a portion of the display with respect to a connection between the at least one portion of the display and the position of the eyes. When the angle is small, the user is looking particularly obliquely at the display, and the offset of the touch point will be particularly large. According to this refinement, the touch point that is determined by the touch-sensitive display forms the basis for determining the input position representing the input request, the touch point then being corrected after it has been established how obliquely the user is looking at the display.

In particular, the angle is based on the angle between the viewing direction, as determined by the position of the eyes and the at least one portion of the display, and the at least one portion of the display, wherein the normal of the at least one portion of the display is considered in the determination of the angle. In other words, the viewing direction is the connection between the position of the eyes and the at least one portion of the display. A normal is perpendicular to a plane. In the case of curved display surfaces, this applies to the point of intersection of the normal, which can also be approximated or averaged and which can be determined for intersecting areas, which here is at least a portion of the display. The normal is, in particular, considered by determining the angle of the viewing direction with respect to a plane that is perpendicular to the normal and makes contact with the display surface, which is to say the display surface itself in the case of a planar display. In this way, the determination of the angle is more detailed.

Moreover, the angle can be determined based on the angle between a projection of the viewing direction onto the display according to the direction of the normal and the viewing direction. In this way, the determination of the angle is more detailed since it takes place between two sections, these being the viewing direction on the one hand, and the projection of the viewing direction on the other. The projection can intersect with the graphical element located closest to the touch point (or in general a point associated with the display or a portion of the display), or to the touch point itself. This can be an end point of the projection. In this way, the determination of the angle can take place independently of whether the position of the eyes is located to the left or to the right of the display; in other words, a rotation of the position of the eyes around the display (at the same level above the display) is to be compensated for.

In an alternative, the angle is based on the angle between the viewing direction, as determined by the position of the eyes and the at least one portion of the display, and a predetermined direction associated with the display, in particular wherein the predetermined direction is perpendicular to the normal of the at least one portion of the display.

With the aid of this alternative, it can be taken into consideration in the determination of the input position whether the user looks at the display from the left or from the right, and to what degree or at what angle the user looks at the display. The predetermined direction can point upward and/or forward, for example, in the case of a display that is installed in a vehicle. In the case of a planar display, the predetermined direction is in particular located in a plane itself. If the display is located in a passenger car, it is therefore also possible to establish whether the driver or the front-seat passenger is operating the display.

In particular, the angle is based on the angle between a projection of the viewing direction on the display according to the direction of the normal in a plane perpendicular to the normal and the predetermined direction associated with the display. This further details that the angle is determined between two sections. The projection is carried out in the direction of the normal to ensure that the angular determination takes place correctly and independently of deviations in the height of the eyes above the display. Ideally, the predetermined direction and the projection are located in the same plane. In the case of a planar display, the viewing direction is projected onto the display.

In a particularly preferred refinement, both the rotation of the position of the eyes around the display, and the height of the position of the eyes above the display, are compensated for by combining the above-described methods.

The detection of the position of the contact can be carried out with the aid of known touch-sensitive devices, in particular devices for the capacitive detection of contacts, wherein the devices are included in the touch-sensitive display. The touch-sensitive display can therefore be a typical touch screen based on the capacitive detection of the touch area. Of course it is also possible to employ techniques such as resistance-based techniques or acoustic surface waves.

Moreover, it may be provided that the general position of the user is detected with the aid of the camera, which is to say, for example, whether the display located in a vehicle is being operated by a driver or a front-seat passenger. The general position can be established based on the preceding orientation or movement of the hand of the user, or of the arm of the user, or the orientation assumed during the input. Based on this determination, the input position can likewise be determined based on the touch position.

In another aspect, a device for determining an input position on a touch-sensitive display by a user comprises the following: the touch-sensitive display; devices for detecting the position of the eyes of a user of the device, in particular comprising a camera; and electronic processing unit, wherein the device is configured to carry out a method described above. The camera can be a camera that creates recordings in the visible light range and/or in the infrared range. The electronic processing unit can executed computer programs and comprise a microprocessor, a microcontroller, dedicated electronic circuits and/or a computer.

The device can be located in a vehicle, in particular a passenger car.

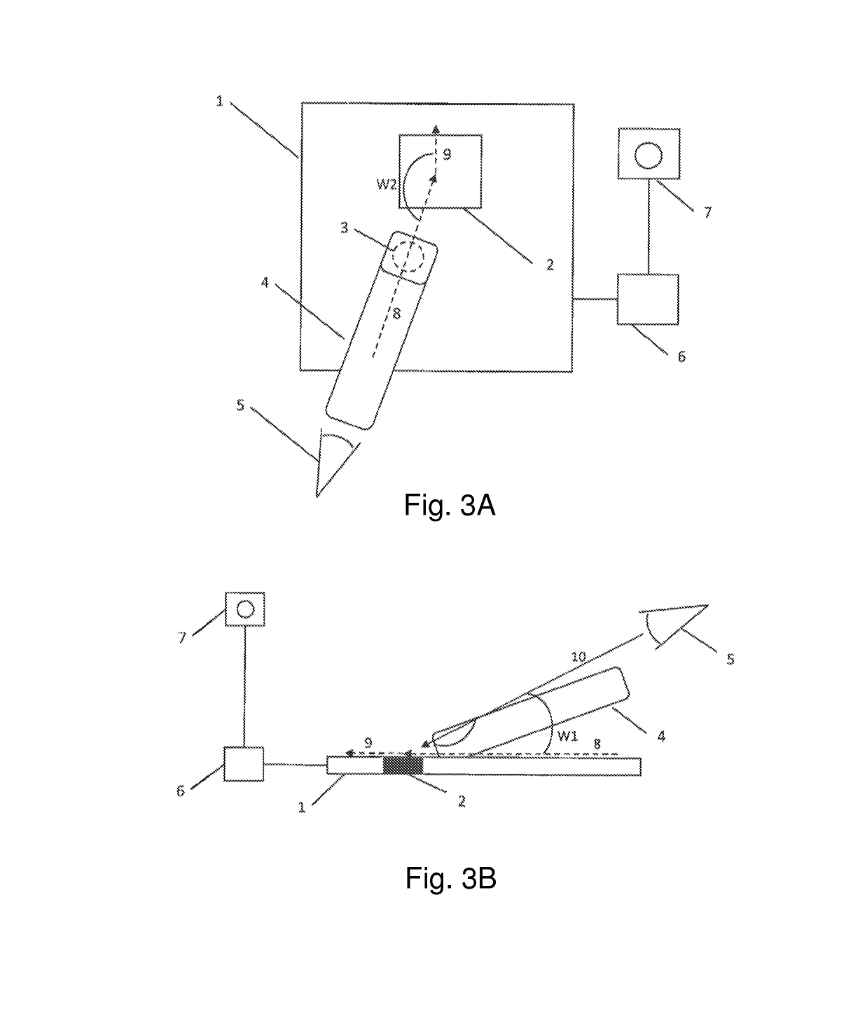

FIGS. 3A and 3B are schematic illustrations of a system according to one exemplary embodiment, which in addition to the elements shown in FIGS. 1A to 2B comprises an electronic processing unit 6 and a camera 7. Identical reference numerals in FIG. 3 denote elements that correspond to those of FIGS. 1A to 2B.

The camera 7 records at least the eyes of the user. The camera 7 is connected to the electronic processing unit 6, to which the camera 7 transmits the recording. Using image processing methods that are known per se, the processing unit 6 determines the position of the eyes 5 of the user. The processing unit 6 also uses the known position of the camera 7 for this purpose.

At the same time or subsequently, the electronic processing unit 6 receives information about the position of the contact and/or information about the touch area from the touch-sensitive display 1, to which the processing unit is connected. Proceeding from this information, the electronic processing unit determines a graphical element of the graphical interface shown on the display 1. This can be the graphical element located closest to the touch position, for example.

Proceeding from this received data, the electronic processing unit 6 determines the angles W1 and W2, based on which the touch position is then corrected so as to determine the input position.

To determine the angles W1 and W2, the processing unit initially projects the connection between one point of the button 2 (or more generally, of a graphical element) and the position of the eyes 5 of the user onto the planar display 1. The dotted arrow represents the projection 8 of the connection; the point of intersection is determined as the centroid of the button 2 and forms the starting or end point of the arrows and directions. The projection 8 takes place perpendicularly to the normal of the planar display 1. FIG. 3B shows the projection 8 slightly above the display 1 for illustrative reasons, although it is in fact located in the planar display. FIG. 3B additionally shows the connection 10 between the button 2 and the eyes 5 of the user. For illustrative reasons, the connection 10 ends just before the button 2, although it extends in fact up to the button 2, for example to the centroid of the button 2. The angle W1 is determined between the projection 8 and the connection 10 (see FIG. 3B).

The angle W2 is determined between the projection 8 and the direction 9 associated with the display 1. The direction 9 is used substantially as an arbitrarily determinable but fixed reference.

The processing unit 6 thereafter determines the input position proceeding from the touch position and the angles W1 and W2. In the present example, the touch position is shifted along the projection 8 by a magnitude determined from the angle W1.

In general, the determination of the input position also takes into consideration the extent to which the button 2 is covered by the finger 4 to the eyes 5 of the user. For example, if the determination of the angle W2, the position of the eyes 5 of the user and the touch area 3 shows that the button 2 is not covered, or is only partially covered, to the view of the user proceeding from the eyes 5, the touch position is not shifted, or is shifted only comparatively little.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for determining an input position on a touch-sensitive display by a user, the method comprising the acts of:
detecting a position of eyes of the user;
detecting a position of a contact by the user with the touch-sensitive display; and
determining the input position based on the detected position of the eyes relative to at least a portion of the touch-sensitive display and the detected position of the contact.

2. The method according to claim 1, wherein the act of detecting the position of the eyes of the user is carried out via a camera.

3. The method according to claim 1, wherein the portion of the touch-sensitive display is a graphical element shown on the touch-sensitive display.

4. The method according to claim 2, wherein the portion of the touch-sensitive display is a graphical element shown on the touch-sensitive display.

5. The method according to claim 1, wherein
the input position is determined proceeding from the position of the contact, which is adapted based on an angle that is associated with the position of the eyes relative to the at least one portion of the display such that the smaller the angle the greater the adaptation, wherein the angle is measured proceeding from the display.

6. The method according to claim 5, wherein
the angle is determined based on an angle between the viewing direction, as determined by the position of the eyes and the at least one portion of the display, and the at least one portion of the display, wherein a normal of the at least one portion of the display is considered in determining the angle.

7. The method according to claim 6, wherein
the angle is determined based on the angle between a projection of the viewing direction onto the display according to the direction of the normal and the viewing direction.

8. The method according to claim 5, wherein
the angle is determined based on the angle between a viewing direction, as determined by the position of the eyes and the at least one portion of the display, and a predetermined direction associated with the display, wherein the predetermined direction is perpendicular to a normal of the at least one portion of the display.

9. The method according to claim 8, wherein
the angle is determined based on the angle between a projection of the viewing direction onto the display according to the direction of the normal and the predetermined direction associated with the display.

10. The method according to claim 6, wherein a further angle is determined based on an angle between a viewing direction, as determined by the position of the eyes and the at least one portion of the display, and a predetermined direction associated with the display, wherein the predetermined direction is perpendicular to a normal of the at least one portion of the display.

11. The method according to claim 8, wherein
the further angle is determined based on an angle between a projection of the viewing direction onto the display according to the direction of the normal and the predetermined direction associated with the display.

12. A device for determining an input position on an apparatus by a user, the device comprising:
a touch-sensitive display;
a camera configured to detect the position of eyes of a user; and
an electronic processing unit;
wherein the electronic processing unit executes a program to:
detect a position of eyes of the user via the camera;
detect a position of a contact by the user with the touch-sensitive display; and
determine the input position based on the detected position of the eyes relative to at least a portion of the touch-sensitive display and the detected position of the contact.
